(19) United States
(12) Patent Application Publication
(10) Pub. No.: US 2006/0189232 A1
(43) Pub. Date: Aug. 24, 2006

(54) Fire retarding, stain and/or mold protecting composition

(75) Inventors: William Kish, Wadsworth, OH (US); Kenneth Rusk, Toledo, OH (US); Karlan C. Kastendieck, St. Charles, MO (US); Keith G. Kastendieck, Washington, MO (US); Mark Harrison, Sherwood park (CA)

Correspondence Address: CHRISTOPHER JOHN RUDY, 209 HURON AVENUE, SUITE 8, PORT HURON, MI, 48060, US

(73) Assignee: NO-BURN INVESTMENTS, L.L.C.

(21) Appl. No.: 11/343,099

(22) Filed: Jan. 30, 2006

Related U.S. Application Data
(60) Provisional application No. 60/656,148, filed on Feb. 23, 2005.
(60) Provisional application No. 60/670,121, filed on Apr. 11, 2005.

(51) Int. Cl. B32B 5/02; B32B 27/04; B32B 27/12

(52) U.S. Cl. 442/59; 442/136; 442/123; 442/124

(57) ABSTRACT

A fire retardant is combined with a stain protectant and/or mold inhibitor especially to inhibit Stachybotrys chartarum. An aqueous spray-on formulation is beneficially provided.

This claims the benefits accorded by 35 USC 119(e) of provisional Nos. 60/656,148 filed on Feb. 23, 2005 A.D., and 60/670,121 filed on Apr. 11, 2005 A.D. The specifications of both of those applications are incorporated herein by reference in their entireties.

### FIELD AND PURVIEW OF THE INVENTION

The invention concerns a composition that is a fire retardant, and a stain protectant and/or mold inhibitor; its making and use. The composition can be provided as a liquid for application, especially spray-on application, to a substrate, beneficially which is otherwise flammable, for example, various textiles. Accordingly, the invention can further concern the composition or its residue in combination with the substrate.

### BACKGROUND TO THE INVENTION

Various fire retardant compositions are known. For example, Fabric Fire Gard spray from No-Burn, Inc. is especially valuable for application to drapes, cloth furniture, and so forth. See also, published U.S. patent applications by Kish et al., Pub. Nos. 2005/0022466 A1 and 2005/0138888 A1. Compare, U.S. patent application Ser. No. 10/132,958 by Mabey, now U.S. Pat. No. 6,989,113.

Various fire retardants with mold inhibitors are known. See, e.g., the aforementioned publications by Kish et al. Compare, U.S. patent application Ser. No. 11/002,730 by Mabey et al., now U.S. Pat. No. 6,982,049

Various other fabric protective compositions are known. Among these are compositions that provide stain-repellency for the fabric such as products available from 3M and Mohawk.

### FULL DISCLOSURE OF THE INVENTION

I. Objects

It is a general object to improve upon the art.

It is a particular object and desire to provide fire retardant and stain repellant or mold inhibitor type properties in a single composition. It is a further particular object to provide a spray-on type fire retardant with stain protectant or mold inhibiting capabilities.

Further objects of the invention are extant, especially as also included in the present disclosure. For example, addition of mold-inhibition to such a fire retardant with stain repellant may be desired, especially while retaining desirable properties of the composition. It is a notable further object to provide for control of toxic black mold (Stachybotrys chartarum), a problematic mold of serious concern, on the materials that are coated with the fire retardant composition.

These and other objects are satisfied, at least in part, by the present invention.

II. Provisions

In general, a composition is provided, which comprises a fire retardant, and stain protectant and/or mold inhibitor. Other aspects of the invention include making the composition and using it by applying it to a substrate, especially as an otherwise combustible material; and the composition or its residue in combination with the substrate.

The invention is useful in enhancing properties of a fire retardant.

Significantly, by the invention, the art is improved in kind. An effective, cost-efficient, aesthetically pleasing and/or generally safe fire retardant having stain protecting and/or mold inhibiting properties is provided. The invention ameliorates or solves one or more of the problems in the art. For instance, flammable textile substrates such as draperies, cloth furniture, bedclothes, carpets, mattresses, fabrics, upholstery, and so forth and the like can be provided with, in the same application, not only fire retardancy but also stain repellency, or not only fire retardancy but also mold inhibition, or not only fire retardancy but also both stain repellency and mold inhibition. Notably, the mold can especially be Stachybotrys chartarum. Application of the composition is simple and easy, especially when it is embodied as a liquid, most especially a spray-on liquid, and coverage can be excellent. Particular embodiments may provide for inhibition of toxic black mold. Addition of the stain protectant and/or mold inhibitor adds notable value to the fire retardant. The composition is fairly inexpensive and reasonably safe to manufacture, store, transport and use. One of the many advantages of the present composition is that, since it can be applied directly to materials, this greatly reduces the financial and environmental costs of rendering materials fire retardant. The composition of the invention can have a “Class A” fire rating. Embodiments of the invention can be considered improvements in kind of the No-Burn Fabric Fire Gard spray-on liquid, adding to such, in particular, exceptional value and utility, noting along these lines parts of the aforementioned publications by Kish et al., which are improved hereby. Numerous further advantages attend the invention.

The invention can be further understood by the additional detail set forth below. The same, like that set forth above, is to be taken in an illustrative and not necessarily limiting sense.

Broadly, in one embodiment, a fire retardant can be combined with a stain repellant. Further embodiments can include the addition of a mold inhibitor to the fire retardant with stain repellant composition, or its employment in lieu of the stain repellant, especially when the fire retardant is a lower viscosity liquid for spray-on application. These are enhanced fire retardants.

A foundation of preferred embodiments of the invention is that a fire retardant base can be prepared, and during or after its preparation can be added the stain repellent and/or mold inhibitor, which, for example, may be added to the base immediately upon its manufacture. Conditions are those sufficient to form the enhanced fire retardant composition of the invention. Stirring or other agitation of the present composition can enhance its uniformity.

The enhancing component(s) may be provided in any suitable amount. For instance, an effective amount of the stain protectant and/or mold inhibitor can be realized as being effective after the composition is applied to, and dried and reached a constant mass on a substrate

The term, “fire retardant,” or the like, as employed herein is a composition that, when applied to a suitable flammable material, provides thermal protection for the material. In general, this may be done by reducing or perhaps even eliminating the tendency of the material to burn and/or reducing the rate of flame spread along the surface of the material. Preferably, use of the fire retardant composition of the invention, for example, on a textile drapery material as the substrate, reduces surface burning characteristics significantly, say, at least about 10%, at least about 25%, or at least about 50%, when compared to untreated material, as tested by an appropriate test. The test can be any suitable test, which may be the ASTM E84 Steiner Tunnel Test. With particular respect to embodiments of the present invention especially adapted for application to such substrates as textiles, nothing causes a more hazardous environment or more fire damage than interior furnishings. Because most interior furnishings in developed countries are now made from synthetic materials, interior fires are burning hotter, faster, and more furiously, within seconds of ignition, which in many cases makes escape nearly impossible. Such synthetic materials give off tremendous amounts of toxic smoke that can incapacitate a person within seconds. As well, interior furnishings make it possible for a fire to “leap” from one end of a home to another within the first few minutes of a fire. Modern sofas, easy chairs, decorations, curtains, carpets and mattresses become extremely volatile, explosive fuels in a fire. This contributes to the most dangerous phase of a fire, “flashover.” Treatment with the composition of the present invention, especially adapted as a liquid or liquid spray-on type formulation, on home furnishings can prevent them from contributing to a fire, dramatically reducing the speed of flame spread, and levels of toxic, choking smoke, which would otherwise be generated. For example, an untreated cloth curtain will quickly catch fire with the application of flame to the curtain. The same type of cloth treated by spraying with a spray-on composition of the invention may simply char and turn black when the flame is applied to it, not catching fire.

Fire retardant formulations can vary, but may include ingredients added with water such as follows in approximate percentages for the fire retardant foundation:

| | |
|---|---|
| Water | 70˜90% to include 76˜82% |
| | by weight |
| Phosphorous containing acid, e.g., as | 5˜15% to include 10˜12% |
| polyphosphoric acid (115%) | by weight |
| Ammonium base, e.g., as hydroxide | 5˜15% to include 8˜40% |
| (29% aqueous solution) | by weight |
| Wetting and/or other agent such as | 0.05˜0.2% to include 0.09˜0.13% |
| coco amidopropyl betaine | by weight |
| (30% aqueous solution) | |
| Preservative, e.g., potassium | 0.01˜0.1% to include 0.04˜0.06% |
| salicylate | by weight. |

As the phosphorous containing acid, any suitable phosphorous containing acidic compound may be employed, to include polyphosphate acids, neat or mixed with a suitable diluent, especially water, and mixtures thereof. Liquid form polyphosphoric acid is preferred. Such an acid may be commercially obtained.

As the ammonium base, any suitable ammonium containing compound may be employed, to include ammonium hydroxide, neat or mixed with a suitable diluent, especially water, and mixtures thereof. Liquid form ammonium hydroxide is preferred. Such a base may be commercially obtained.

The phosphorous containing acid and ammonium base may be provided as an ammonium phosphate salt, to include mono, di, tri or polyphosphates. It may a solid, which may be provided as a powder. Such a salt may be a mixture containing mono- and di-ammonium phosphates. Liquid salts would be preferred. Such a salt may be commercially obtained.

Wetting and/or other agent(s) may be employed. Such agent(s) can include what may be considered surface tension lowering agents, surfactants, defoaming agents, dispersing agents, preservatives, which may be biocidal, and so forth and the like. For instance, such wetting and/or other agent(s) can include compounds such as follows:

| | |
|---|---|
| Surfactant | Coco amidopropyl betaine |
| Preservative | Salicylate salt, e.g., of potassium. |
| | A quaternary ammonium salt may be employed, |
| | which may also function as a mold inhibitor. |

A quaternary ammonium salt may be employed, which may also function as a mold inhibitor.

To such a fire retardant foundation or any other suitable fire retardant formulation, or precursor part thereof, is/are provided the stain protectant and/or mold inhibitor.

The term, “stain protectant,” or the like, as employed herein is a composition that, when applied to a textile fabric such as upholstery in combination with the fire retardant foundation or other fire retardant composition, which can include a fire retardant in combination with a mold inhibitor, provides stain repellant or soil releasing capability. Such may be measured by any suitable test method.

Any suitable stain protectant may be employed in the practice of the present invention. As the stain protectant may be mentioned a fluoropolymer stain protectant, for example, a fluoroaliphaticpolyacrylate fluoropolymer, which is commercially obtainable as Masurf FP-815 CP (16% active ingredient) from Mason Chemical. Another stain protectant, which, for example, may be employed in the practice of the present invention, is Repel-O-Tex product from Rhone-Poulenc.

The stain protectant may be added in any suitable amount. It may be added in an amount by weight of base fire retardant foundation, independently at each occurrence, about from 0.1% to 5%, to include about from 0.2% to 1% or 2%, and about from 0.25% to 0.75%, by weight. For instance, the stain protectant may be added at about 0.5% by weight of the base fire retardant foundation.

The term, “mold inhibitor,” or the like, as employed herein is an agent that can kill, control, or prevent growth of mold, mildew, or fungus, and so forth and the like flora, especially when formulated with a basic fire retardant or a fire retardant with stain protectant. A mold inhibitor may be fire retardant or fire accelerative, but, in the latter case, does not accelerate fire to a degree that the overall composition which contains the mold inhibitor cannot be considered to be a fire retardant composition. Preferably, however, use of the fire retardant, or fire retardant and stain protectant, with mold inhibitor, for example, on a standard solid or textile material as the substrate, reduces growth of the flora of interest significantly, say, at least about 60%, at least about 85%, or at least about 99% or even at least about 99.9%, if it does not kill it outright, for a significant time, say, at least about thirty days, at least about six months, or at least about 360 days or a year, if not, in effect, indefinitely, as tested by appropriate test methodology. The test may be by any suitable test method, which may be ASTM D5590-94, Determination of Resistance of a Coating Material to Fungal Growth.

As the mold inhibitor, any suitable substance may be employed. Preferably, the mold inhibitor is compatible with the other components, and further is soluble or suspendable therewith. For instance, the mold inhibitor may be a quaternary ammonium salt, for instance, a quaternary organic ammonium halide. The halide is advantageously a chloride. The quaternary organic ammonium halide may be a quaternary alkyl ammonium halide, especially such a halide having at least one short chain and at least one medium chain alkyl group, for example, two of each, and an otherwise corresponding quaternary alkyl aromatic ammonium halide. The short chain alkyl group may be inclusive of, independently at each occurrence, a one- to an about five-carbon group, especially a one- to four-carbon group, for example, a methyl, ethyl, propyl, and so forth group. The medium chain alkyl group may be inclusive of, independently at each occurrence, an about six- to an about thirty-carbon group, especially a six- to an about twenty-carbon group, for example, hexyl, heptyl, octyl, nonyl, decyl, undecyl, dodecyl, a thirteen-, fourteen-, fifteen- or sixteen-, seventeen-, eighteen-, nineteen-, or twenty-carbon group, and so forth. Preferably, the short chain alkyl group is methyl and/or ethyl, especially methyl, and the medium chain alkyl group is an eight- to twelve-carbon group, to include a mixture thereof, especially decyl, which can be present as an n-alkyl group. For example, the mold inhibitor may be didecyldimethylammonium chloride. An aromatic group, to include aryl, alkaryl and/or arylalkyl, for example, a benzyl and/or ethylbenzyl group may be present, for instance, in a quaternary organic to include a quaternary alkyl aromatic ammonium halide mold inhibitor, for example, alkyldimethylbenzylammonium chloride. The mold inhibitor may be a mixture containing more than one mold inhibitor compound. An increase in concentration of any quaternary ammonium halide mold inhibitor may provide for a corresponding reduction in the amount of the ammonium phosphate salt, which, again, can be provided from the aforementioned acid and base.

The mold inhibitor may be added in any suitable amount. It may be added in an amount by weight of base fire retardant foundation or fire retardant with stain protectant, independently at each occurrence, about from 0.1% to 15%, to include about from 0.5% to 10%, about from 1% to 5%, and about from 2% to 4%, by weight. For instance, a target amount of the mold inhibitor may be about 3% by weight of the base fire retardant foundation or fire retardant with stain protectant of the invention.

Other additive(s) may be employed.

Substances such as opacifying agent(s), pigment(s), tint(s) and/or color(s) may be added to obtain an opaque, vivid, pastel or colored composition. Such substances such as perfume(s) may be added. Such substances, however, are preferably absent to afford, in general, a colorless and odorless composition.

The fire retardant with stain protectant and/or mold inhibitor of the invention may penetrate to some degree, especially with cloth textiles. More than one coat may be needed to cover completely. One coat, however, may suffice. However that may be, preferably, once dried, it leaves a generally colorless residue on a flammable solid substrate, which is believed to be relatively safe in application and after drying. Suitable precautions, however, should be undertaken. Advantageously, there is nothing in the formulation of the present invention known to be substantially harmful to textiles per se, wood per se, plywood, any other wood product, or the paper of gypsum board or the paper in inaccessible areas of upholstered furniture such as under seats of office chairs, in general. What is more, the composition can be most beneficial in its stain protectant and/or mold inhibitory characteristic(s).

The present fire retardant composition with stain protectant and/or mold inhibitor may be applied to the materials by any suitable method. Known methods may be employed. It may be applied by spraying, say, by hand-held trigger sprayers, pump-up pressure sprayers, or any other type of manual or automatic power-assisted spraying apparatus; airless sprayers; brushing; dipping; and so forth. Advantageously, the wet composition is applied by spraying, for example, with a pump type sprayer, or from an aerosol container such as a can powered with a propellant. These and other application processes are well known in the art and are subject to many variations. The composition of the present invention is applied at any suitable concentration or rate to produce a material treated with an effective amount of fire retardant with stain protectant and/or mold inhibitor.

The following examples further illustrate the invention. Therein, parts and percentages are given by weight, unless otherwise specified.

### EXAMPLE 1

In a clean, appropriately sized, cooling-jacketed mixer, the following component ingredients were added in the order shown to make a fire retardant with stain protectant of the invention:
100 gallons of a fire retardant foundation of water (79.34%); 115% polyphosphoric acid (11.08%); 29% aqueous solution of ammonium hydroxide (9.42%);
   30% aqueous solution of coco amidopropyl betaine (0.11%); and
   200 grams potassium salicylate preservative (0.05%); plus
4.5 pounds of a stain protectant of Masurf FP-815 CP, a 16% active fluoraliphaticpolyacrylate fluoropolymer, effective as a soil releasing fabric protectant (Mason Chemical).

The ingredients were stirred until the temperature of the solution fell below a 30-degree C. value. A colorless, odorless liquid was provided.

### EXAMPLE 2

The composition of Example 1 is tested on suitable fabric against the fire retardant foundation from Example 1 and against the fabric alone, for fire retardant and stain repellant properties. The composition of Example 1 has effective fire retardant and stain repellant properties.

### EXAMPLE 3

To 100 grams of finished composition of Example 1 is added about 3⅔ grams of alkyldimethylbenzylammonium chloride (as an 80% aqueous solution). The ingredients are stirred to provide a liquid composition.

### EXAMPLE 4

The composition of Example 3 is tested on suitable fabric against the finished composition of Example 1, against the fire retardant foundation from Example 1, and against the fabric alone, for fire retardant, stain repellant, and mold inhibition properties. The composition of Example 3 would have effective fire retardant, stain repellant, and mold inhibition properties.

### EXAMPLE 5

In a clean, appropriately sized, cooling-jacketed mixer, the following component ingredients may be added in the order shown to make a fire retardant foundation:
100 gallons of a fire retardant foundation of water (79.34%); 115% polyphosphoric acid (11.08%); 29% aqueous solution of ammonium hydroxide (9.42%);
   30% aqueous solution of coco amidopropyl betaine (0.11%); and
   200 grams potassium salicylate preservative (0.05%).

The ingredients may be stirred until the temperature of the solution is found to fall below a 30-degree C. value. A colorless, odorless liquid fire retardant foundation may thus be provided.

To 100 grams of the fresh fire retardant foundation may be added about 3⅔ grams of alkyldimethylbenzylammonium chloride (as an 80% aqueous solution). The ingredients may be stirred to provide a liquid fire retardant with mold inhibitor composition of the invention.

### EXAMPLE 6

The composition of Example 5 may be tested on suitable fabric against the fire retardant foundation from Examples 1 or 5 and against the fabric alone, for fire retardant and mold inhibition properties. The composition would show effective fire retardancy and mold inhibition.

### CONCLUSION TO THE INVENTION

The present invention is thus provided. Various features, parts, steps, subcombinations and/or combinations may be employed with or without reference to other features, parts, steps, subcombinations and/or combinations in the practice of the invention, and numerous adaptations and modifications can be effected within its spirit, the literal claim scope of which is particularly pointed out as follows:

What is claimed is:

1. A composition comprising combined fire retardant and stain protectant components.

2. The composition of claim 1, which is aqueous.

3. The composition of claim 2, which is suitable for spray-on application, wherein the fire retardant component includes ingredients in approximate percentages by weight as follows:

| | |
|---|---|
| Water | 70˜90%; |
| Phosphorous containing acid | 5˜15%; |
| Ammonium base | 5˜15%; |
| Wetting and/or other agent | 0.05˜0.2%; |
| Preservative | 0.01˜0.1%; |

and wherein the stain protectant is present in an amount that, when applied to an upholstery textile fabric in combination with the remainder of the composition, provides stain repellant or soil releasing capability to the upholstery textile fabric.

4. The composition of claim 1, wherein the stain protectant includes a fluoraliphaticpolyacrylate fluoropolymer.

5. The composition of claim 2, wherein the stain protectant includes a fluoraliphaticpolyacrylate fluoropolymer.

6. The composition of claim 3, wherein the stain protectant includes a fluoraliphaticpolyacrylate fluoropolymer.

7. The composition of claim 1, further comprising a mold inhibitor.

8. The composition of claim 3, further comprising a mold inhibitor.

9. The composition of claim 7, wherein the mold inhibitor includes a quaternary organic ammonium halide.

10. The composition of claim 8, wherein the mold inhibitor includes a quaternary organic ammonium halide.

11. The composition of claim 10, wherein said halide includes a quaternary organic ammonium chloride.

12. The composition of claim 11, wherein said chloride includes an alkyldimethylbenzylammonium chloride.

13. The composition of claim 3, wherein:
the fire retardant component includes that the water is present about from 76% to 82% by weight; the phosphorous containing acid includes being provided as a polyphosphoric acid, and is present about from 10% to 12% by weight; the ammonium base includes being provided as a hydroxide, and is present about from 8% to 10% by weight; the wetting and/or other agent includes being provided as coco amidopropyl betaine, and is present at about from 0.09% to 0.13% by weight; and the preservative includes being provided as potassium salicylate, and is present at about from 0.04% to 0.06% by weight; and
the stain protectant includes being provided as a fluoraliphaticpolyacrylate fluoropolymer, and is present about from 0.1% to 2% by weight of the fire retardant component.

14. The composition of claim 13, further comprising a mold inhibitor that includes a quaternary organic ammonium halide, and the mold inhibitor is present at about 0.1% to 15% by weight of the fire retardant component.

15. The composition of claim 14, wherein said halide includes an alkyldimethylbenzylammonium chloride, and is present about from 2% to 4% by weight of the fire retardant component.

16. The composition of claim 1, which is made in exact or approximate proportion to the following general formulation:
gallons of a fire retardant foundation of water (79.34%); 115% polyphosphoric acid (11.08%); 29% aqueous solution of ammonium hydroxide (9.42%);
30% aqueous solution of coco amidopropyl betaine (0.11%); and
200 grams potassium salicylate preservative (0.05%); plus
4.5 pounds of a stain protectant of a 16% active fluoraliphaticpolyacrylate fluoropolymer.

17. In combination, the composition of claim 1; and a substrate.

18. The combination of claim 17, wherein the substrate is otherwise a flammable textile.

19. A composition of matter comprising combined fire retardant and mold inhibitor components, which is suitable for spray-on application, wherein the fire retardant component includes ingredients in approximate percentages by weight as follows:

| | |
|---|---|
| Water | 70˜90%; |
| Phosphorous containing acid | 5˜15%; |
| Ammonium base | 5˜15%; |
| Wetting and/or other agent | 0.05˜0.2%; |
| Preservative | 0.01˜0.1%; |

and wherein the mold inhibitor is present in an amount effective for kill, control, or prevention of growth of Stachybotrys chartarum after the composition is applied to, and dried and reached a constant mass on a substrate.

20. A method for making and/or using a composition embracing combined fire retardant and enhancing component(s) of a stain protectant and/or mold inhibitor as set forth below, comprising carrying out the method, wherein:
the method of making comprises preparing a fire retardant base, and contacting it with the enhancing component(s), under conditions sufficient to form the composition; provided that, if the enhancing component does not include the stain protectant, the fire retardant base includes ingredients in approximate percentages by weight as follows:

| | |
|---|---|
| Water | 70˜90%; |
| Phosphorous containing acid | 5˜15%; |
| Ammonium base | 5˜15%; |
| Wetting and/or other agent | 0.05˜0.2%; |
| Preservative | 0.01˜0.1%; |

and the mold inhibitor is present in an amount effective for kill, control, or prevention of growth of Stachybotrys chartarum after the composition is applied to, and dried and reached a constant mass on a substrate; and
the method of using comprises providing the composition and applying it to a substrate.
